(19) United States
(12) Patent Application Publication
(10) Pub. No.: US 2008/0252785 A1
(43) Pub. Date: Oct. 16, 2008

(54) System and method for aiding user in making correct TV connections

(76) Inventor: Robert Hardacker, Escondido, CA (US)

Correspondence Address: ROGITZ & ASSOCIATES, 750 B STREET, SUITE 3120, SAN DIEGO, CA, 92101, US

(21) Appl. No.: 11/786,066

(22) Filed: Apr. 10, 2007

(51) Int. Cl. H04N 5/445

(52) U.S. Cl. 348/563

(57) ABSTRACT

A TV has a TV processor and a display presenting a map showing the topology of the home network of which the TV is a part. The TV determines whether correct connections with other components have been made and if not, indicates the incorrect connections on a map displayed on the TV.

### I. FIELD OF THE INVENTION

The present invention relates generally to TV-centric home entertainments systems that aid users in making correct connections between TVs and other components.

### II. BACKGROUND OF THE INVENTION

As home networks proliferate and improve, they grow more complex with the addition of new devices. For example, a home network may be centered on a TV that can receive information not only from a cable modem and satellite dish but also from digital video recorders (DVRs), digital video disk (DVD) players, and even an in-home computer and the Internet. As understood herein, even technical users can be daunted by visualizing and understanding network participation and connectivity, let alone undertake initial connections of new devices to the networks typically accompanied by authentication and handshaking protocols, updating devices with new software, understanding network connectivity and component availability (or not) for user-desired functions, etc. With these recognitions in mind, the invention herein is provided.

### SUMMARY OF THE INVENTION

A TV includes a TV processor that displays a network map on the TV. The map displays visual depictions of the TV, components, and actual or candidate interconnections therebetween. The network map shows connections ports of the TV and of at least one component and also indicates whether the component is correctly connected to the TV.

The ports may be color coded. For example, a first color can be used to designate a first port on the TV and the first color also may be used to designate a first port on the component that properly should be connected to the first port on the TV. Then, a second color can be used to designate a second port on the TV and the second color is also used to designate a second port on the component that properly should be connected to the second port on the TV.

In one embodiment the TV processor can determine the propriety of a connection between the TV and component by sensing a voltage of, e.g., one or more connector ports of the TV. As an example, if the component is connected to the TV through left and right analog lines and a composite video line, and if a predetermined voltage is sensed at a composite video port of the TV and is not sensed on left and right analog ports, correct connection can be indicated. On the other hand, if the voltage is sensed at one of the left and right analog ports, incorrect connection is indicated.

As another alternative, the TV processor can command the component to energize. The TV processor can then determine, sensing signals at one or more ports to which the component is connected, whether a correct connection has been made.

In another aspect, a TV includes a TV processor, and one or more components are connected to the TV. The TV processor determines the propriety of a connection between the TV and component by sensing a voltage.

In still another aspect, a TV includes a TV processor, and one or more components are connected to the TV. The TV processor commands the component to energize and then determines, by sensing signals at one or more ports to which the component is connected, whether a correct connection has been made.

The details of the present invention, both as to its structure and operation, can best be understood in reference to the accompanying drawings, in which like reference numerals refer to like parts, and in which:

### BRIEF DESCRIPTION OF THE DRAWINGS

FIG. 1 is a block diagram of a non-limiting TV-centric system in accordance with the invention; and

FIG. 2 is a screen shot showing a non-limiting network map.

### DETAILED DESCRIPTION OF THE PREFERRED EMBODIMENT

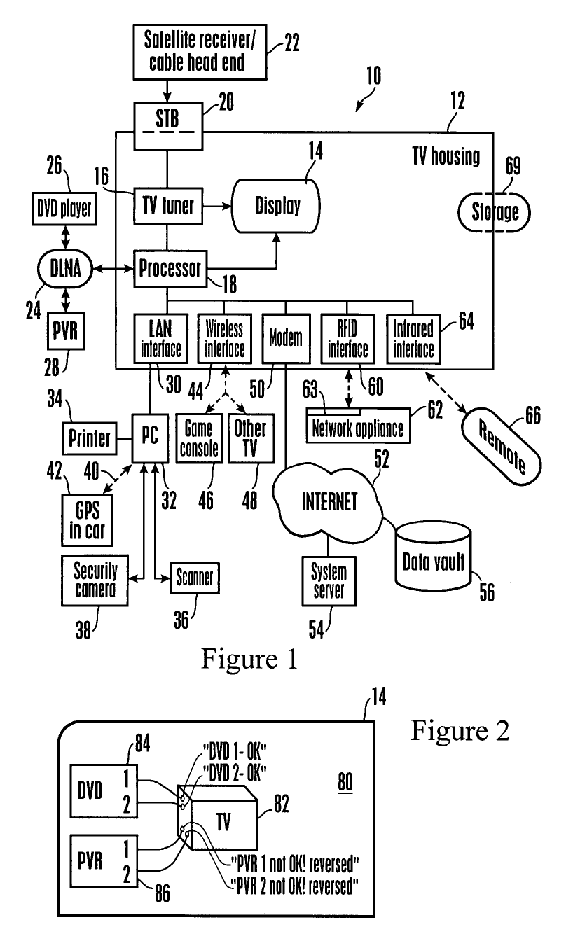

Referring initially to FIG. 1, a system is shown, generally designated 10, which includes a TV housing 12 holding TV components including a TV display 14, an optional TV tuner 16 (which can be implemented as an ATSC tuner, Internet modem, etc.), and a TV processor 18. The TV tuner 16 may receive input from a set-top box (STB) 20 that, as indicated in FIG. 1, can be part of the housing 12 or alternatively can be in a housing separate from the housing 12. In any case, the STB 20 receives audio-video signals from one or more sources 22 such as but not limited to satellite receivers, cable system head ends, broadcast receiver antennae, etc. Depending on the nature of the signal, it may be sent directly to the display 14 from the tuner 16 or sent first through the processor 18 for subsequent display. It is to be understood that the STB 20 can communicate with the TV not only through the tuner 16 but also via i-link, high definition multimedia interface (HDMI), RF including WiFi, WiMedia, and 60 GHz, Ethernet connection, and other communication forms.

The non-limiting embodiment shown in FIG. 1 illustrates that the present TV can be connected to a plurality of external systems and networks, it being understood that in some implementations not all the components shown in FIG. 1 need be used. In essence FIG. 1 shows a comprehensive TV-centric system for completeness.

In one embodiment, the TV processor 18 may communicate with a digital living network association (DLNA) system 24. Also connected to the DLNA system 24 can be various components including but not limited to a disk player such as a DVD player 26 or Blu-Ray disk player and a personal video recorder (PVR) 28. Information including multimedia streams such as TV programs and movies can be exchanged between the TV processor 18 and the DVD player 26 and PVR 28 in accordance with DLNA principles known in the art.

A local area network (LAN) interface 30 may be provided in the TV housing 12 and connected to the TV processor 18, so that the TV processor 18 can communicate with components on a LAN, implemented in some embodiments as an Ethernet. These components may include a personal computer 32 or other computer, and the computer 32 can communicate with computer network peripheral equipment such as but not limited to a printer 34, a scanner 36, and a security camera 38. All or parts of the computer network may overlap with the various networks with which the TV processor 18 communicates as discussed more fully below.

In addition to Ethernet links, the LAN may include one or more wireless links 40, so that the PC 32 (and, hence, the TV processor 18) may communicate with wireless components such as a vehicle-mounted global position satellite (GPS) receiver 42. Without limitation, the wireless link 40, like other wireless links herein, may be, e.g., an 802.11 link, a Wi-Fi link, a Bluetooth link, an IR link, an ultrasonic link, etc. A telephony pager network can be used.

In some implementations, a pre-existing computer LAN might exist in the form of twisted pair wiring, coaxial wiring, etc. in a house, and it might be desired to use the pre-existing LAN for the TV components to establish a shared network. In such a case, the physical media is shared between the PC 32 and TV processor 18 with associated components. In one embodiment, the TV components can use a first protocol such as a proprietary protocol while the PC 32 and associated peripherals can use a different, second protocol, so that communication interference is avoided. If a common protocol is used, undesirable devices from the TV standpoint (such as, e.g., the printer 34 and scanner 36) can be removed from the TV network so that, for example, they do not appear on the below-described TV network maps.

When the same protocol is used between the TV processor 18 and the PC 32, the TV processor 18 can be given arbiter rights to manage bandwidth for audio/video data transmissions in the network, and the PC 32 can be given arbiter rights to manage bandwidth for non-audio/video data transmissions. Also, the TV processor 18 may “see” the PC 32 in the TV network but this does not mean that the PC 32 necessarily recognizes the TV components to be part of its network.

Apart from the wireless link 40 of the LAN with which the TV processor 18 may communicate, a wireless communication interface 44 may be in the TV housing 12 and may communicate with the TV processor 18 as shown. The wireless communication interface may wirelessly communicate with various components such as but not limited to a video game console 46, such as a Sony Playstation®, and another TV 48 that might be located in, e.g., another room of the same dwelling. The communicated data may include, e.g., control data to remote devices, acknowledgement messages, streamed content contained in various data stores in the network, streamed real time audio-video content, etc.

Also, portable devices may connect to the system via wired or wireless paths. These portable devices can include digital still cameras, digital video cameras, audio players, video players, and wireless telephones which may be sources of still pictures, music, vide, and the like.

The processor 18 may also communicate with a computer modem 50 in the TV housing 12 as shown. The modem 50 may be connected to the Internet 52, so that the TV processor 18 can communicate with a web-based system server 54 and a web-based data vault 56. The server 54 may be an IPTV server in which the TV tuner is essentially located in the head end (server 54) or it may be another type of server. The servers herein may be local or remote or a combination thereof.

In addition to the wireless communication interface 44 and the modem 50, the TV processor 18 may communicate with a radiofrequency identifier (RFID) interface 60 in the housing 12 or attached thereto using, e.g., a uniform serial bus (USB) cable, to facilitate communication in accordance with RFID principles known in the art between the TV processor 18 and an RFID-enabled network appliance 62 having an RFID device 63 mounted on it or connected to it. Furthermore, the TV processor 18 can, through an infrared interface 64, receive user commands from a remote control device 66 that transmits IR signals, it being understood that the remote control device 66 may alternately use RF, in which case the interface 64 would be an RF interface.

FIG. 1 also shows that the TV can have a data storage 69. The storage 69 may be flash or ROM or RAM in the TV and/or it may be a removable memory device such as a Sony Memory Stick®.

Now referring to FIG. 2, a map 80 is shown presented on the TV display 14. The map 80 shows a TV icon 82 and one or more component icons, such as a DVD icon 84 and a PVR icon 86. The TV icon 82 illustrates the various ports of the TV to which the DVD player 26 can be connected, as well as TV ports to which the PVR 28 can be connected. Likewise, on the DVD icon 84 and PVR icon 86 respective connection ports are shown. Only two ports per component are shown for simplicity of illustration, it being understood that more than two ports may be allocated depending on the component.

Preferably, the ports are displayed on the map 80 using color coding. Thus, for example, the port labeled “1” on the DVD icon 84 might be blue, and the corresponding port labeled “DVD 1” on the TV icon 82 is also colored blue, with other component port-TV port pairs being likewise similarly colored to each other and differently from the other port pairs.

Additionally, when the DVD 26 and PVR 28 are connected to the TV, the map 80 can indicate whether the connections are correct. Specifically, as shown the map 80 indicates that the DVD connections are “OK” but that the PVR connections are not, e.g., that two PVR leads have been reversed.

In some implementations the TV processor 18 can determine the propriety of a connection between the TV and a component by sensing a voltage of a confection line/port of the TV. As a non-limiting example, suppose a component is connected to the TV through left and right analog lines and a composite video line such as but not limited to a composite video, blanking, and sync (CVBS) line. If a predetermined “correct” composite video voltage (e.g., 3.58 volts) is sensed at the TV port associated with the composite video line and is not sensed on left and right analog ports, correct connection is indicated. In contrast, if the composite video voltage is sensed at the left and/or right analog ports, incorrect connection is indicated.

As another alternative, frequency may be sensed to determine the propriety of a connection. For example, recognizing that color operates at a specific frequency such as 3.5795 MHz, a bandpass filter and voltage detector may be provided to identify the presence of the chroma subcarrier at, e.g., 3.58 MHz, and if such a frequency is not sensed at a port that is supposed to be connected to a chroma connection, and improper connection is indicated, and vice-versa. This can be applied to determining connections for CVBS and left/right audio For RGB/YPrPb, the presence (properly or not) of “Y” can be detected by detecting a sync with a pulse at the line rate (480i is about 15.7 KHz; 480p is about 30.4 KHz, etc.) This can be used in conjunction with energizing a component. Specifically, if a component is commanded to energize the port (e.g. video 1, video 2, HDMI 1, HDMI 2, etc.) to which the component is connected can be identified. Then, a test signal can be analyzed for analog ports such as YPrPb/RGB. Once it is ascertained, e.g., which port is “Y” per the above description, a red test field may be output and the PR can be identified by having much signal whereas Pb should have very little signal when the test signal is a red field. The opposite will then be true for a test field that is blue.

Alternatively, the TV processor 18 may command the various components in the system that are connected to the TV to energize. Then, the processor 18 can determine (by, e.g., sensing voltage or data signals at ports to which the components are connected) whether a correct connection has been made.

The map 80 can be created by the TV processor 18 automatically, upon initial connection and optionally also on every subsequent energization, “discovering” networked devices in accordance with network discovery principles known in the art. Or, a user may be permitted to manually input data to construct the map 80 using the remote control device 66. To this end, near field communications (RFID) can be used, or a keyboard, or a menu selection process, etc.

If the interface is HDMI then the cyclic error code (CEC) line can be used to identify the device at the other end. The server can be used to provide “good”, “better”, and “best” connectivity recommendations to the user based on, e.g., optimum bandwidth, lowest bit error rate, etc. Upon the addition of a new component, the recommendations can change, since the presence of the new component can effect error rates, bandwidth, etc. As understood herein, if the TV type/model is known, the available interfaces and capabilities also are known, and as non-TV devices are added to the network to communicate with the TV, their capabilities can be looked up by the TV processor using, e.g., an online database to thus provide connectivity recommendations, as well to provide visual depictions on the screen of the TV of the interfaces of each device with good, better, and best indicated on the depictions by words, color coding, etc. The depictions can be photorealistic images, photographs, drawings, etc.

Additionally, the TV processor 18 may upload map 80 information via the modem 50 to the Internet system server 54. In response, the server 54 can return updated device information, diagnostic information, etc. to the TV processor 18, so that the map can be updated accordingly. This information can be stored in the network to establish a connections database.

Still further, if desired as devices are discovered during the process discussed above and added to the connections database, automatic authentication of network components/appliances can be undertaken by the TV, relieving the user of this chore. Thus, the entire network can be automatically configured by the TV, while automatically establishing and/or allowing a user to select optimum bandwidth and resource allocation across various network paths, optimum performance for a particular function, and distributed storage of media both on the network and using the Internet.

While the particular SYSTEM AND METHOD FOR AIDING USER IN MAKING CORRECT TV CONNECTIONS is herein shown and described in detail, it is to be understood that the subject matter which is encompassed by the present invention is limited only by the claims.

What is claimed is:

1. A system, comprising:
a TV including a TV processor displaying a network map, the map displaying visual depictions of the TV, at least one component, and at least one actual or candidate interconnection therebetween;
the network map showing connections ports of the TV and of at least one component;
the network map indicating whether the component is correctly connected to the TV.

2. The system of claim 1, wherein the network map shows connections ports of the TV and of at least one component, and further wherein the ports are color coded on the map.

3. The system of claim 2, wherein a first color is used to designate a first port on the TV and the first color is also used to designate a first port on the component that properly should be connected to the first port on the TV, a second color being used to designate a second port on the TV and the second color being also used to designate a second port on the component that properly should be connected to the second port on the TV.

4. The system of claim 1, wherein the processor determines the propriety of a connection between the TV and component at least in part by sensing a voltage.

5. The system of claim 4, wherein the voltage is sensed of at least one connector port of the TV.

6. The system of claim 5, wherein the component is connected to the TV through left and right analog lines and a composite video line, and if a predetermined voltage is sensed at a composite video port of the TV and is not sensed on left and right analog ports, correct connection is indicated, and if the voltage is sensed at least one of the left and right analog ports, incorrect connection is indicated.

7. The system of claim 1, wherein the processor commands the component to energize, the processor determining, sensing signals at least one port to which the component is connected, whether a correct connection has been made.

8. A system, comprising:
a TV including a TV processor;
at least one component connected to the TV, wherein the processor determines the propriety of a connection between the TV and component at least in part by sensing a voltage and/or a frequency.

9. The system of claim 8, wherein the voltage is sensed of at least one connector port of the TV.

10. The system of claim 9, wherein the component is connected to the TV through left and right analog lines and a composite video line, and if a predetermined voltage is sensed at a composite video port of the TV and is not sensed on left and right analog ports, correct connection is indicated, and if the voltage is sensed at least one of the left and right analog ports, incorrect connection is indicated.

11. The system of claim 8, wherein the processor displays a network map showing connections ports of the TV and of the component, the network map indicating whether the component is correctly connected to the TV.

12. The system of claim 11, wherein the ports are color coded on the map.

13. The system of claim 12, wherein a first color is used to designate a first port on the TV and the first color is also used to designate a first port on the component that properly should be connected to the first port on the TV, a second color being used to designate a second port on the TV and the second color being also used to designate a second port on the component that properly should be connected to the second port on the TV.

14. A system, comprising:
a TV including a TV processor;
at least one component connected to the TV, wherein the processor commands the component to energize, the processor determining, sensing signals at least one port to which the component is connected, whether a correct connection has been made.

15. The system of claim 14, wherein the processor displays a network map showing connections ports of the TV and of the component, the network map indicating whether the component is correctly connected to the TV.

16. The system of claim 15, wherein the ports are color coded on the map.

17. The system of claim 16, wherein a first color is used to designate a first port on the TV and the first color is also used to designate a first port on the component that properly should be connected to the first port on the TV, a second color being used to designate a second port on the TV and the second color being also used to designate a second port on the component that properly should be connected to the second port on the TV.
